(19) United States
(12) Patent Application Publication
(10) Pub. No.: US 2014/0131594 A1
(43) Pub. Date: May 15, 2014

(54) METHOD FOR GENERATING ELECTRON BEAMS IN A HYBRID LASER-PLASMA ACCELERATOR

(71) Applicant: THE REGENTS OF THE UNIVERSITY OF CALIFORNIA, Oakland, CA (US)

(72) Inventors: Bernhard Hidding, Dusseldorf (DE); James Rosenzweig, Los Angeles, CA (US); David Bruhwiler, Boulder, CO (US); Georg Pretzler, Dusseldorf (DE)

(73) Assignee: THE REGENTS OF THE UNIVERSITY OF CALIFORNIA, Oakland, CA (US)

(21) Appl. No.: 14/106,612

(22) Filed: Dec. 13, 2013

Related U.S. Application Data
(63) Continuation of application No. PCT/US2012/043002, filed on Jun. 18, 2012.

(30) Foreign Application Priority Data
Jun. 18, 2011 (DE) 102011104858.1

(51) Int. Cl. G21K 5/00

(52) U.S. Cl. CPC G21K 5/00
USPC 250/503.1

(57) ABSTRACT

A method for testing the sensitivity of electronic components and circuits against particle and photon beams using laser-plasma interaction, in which the flexibility of the multifaceted interaction can produce several types of radiation such as electron, proton, ion, neutron and photon radiation, and combinations of these types of radiation, in a wide range of parameters that are relevant to the use of electronic components in space, such as satellites, at high altitudes or in facilities that work with radioactive substances such as nuclear power plants. Relevant radiation parameter ranges are accessible by this method, which are hardly accessible with conventional accelerator technology. Because of the compactness of the procedure and its versatility, radiation testing can be performed in smaller laboratories at relatively low cost.

### CROSS-REFERENCE TO RELATED APPLICATIONS

This application is a 35 U.S.C. §111(a) continuation of PCT international application number PCT/US2012/043002 filed on Jun. 18, 2012, incorporated herein by reference in its entirety, which claims priority under 35 U.S.C. §§119(a)-(d) to German patent application No. 10 2011 104 858.1 entitled “Verfahren zur Erzeugung von hochenergetischen Elektronenstrahlen ultrakurzer Pulslänge, Breite, Divergenz and Emittanz in einem hybriden Laser-Plasma-Beschleuniger”, filed in the German Patent Office DPMA on Jun. 18, 2011, incorporated herein by reference in its entirety.

The above-referenced PCT international application was published as PCT International Publication No. WO 2012/177561 on Dec. 27, 2012 and republished on May 30, 2013, which publications are incorporated herein by reference in their entireties.

### STATEMENT REGARDING FEDERALLY SPONSORED RESEARCH OR DEVELOPMENT

Not Applicable

### INCORPORATION-BY-REFERENCE OF MATERIAL SUBMITTED IN A COMPUTER PROGRAM APPENDIX

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND OF THE INVENTION

1. Field of the Invention

This invention pertains to a method for generating high-quality electron beams in a compact, plasma-based setup. Such beams have high scientific, industrial and economic relevance because they are needed for novel light sources such as free-electron-lasers (FEL) for medical applications and material science, for example.

2. Description of Background Art

For most of the foregoing applications, it is highly desirable for the beams to have very short durations, transversal size, low divergence and emittance, and low energy spread. Such bunches should have durations of a few femtoseconds, bunch widths of a few micrometers, and correspondingly high bunch electron densities.

Plasma-based accelerators are superior when compared to conventional accelerators primarily in that they allow for extremely high accelerating electric fields up to teravolts-per-meter. In contrast, the accelerating fields in superconducting state-of-the-art electron accelerators based on radiofrequency-cavity technology are limited to a few tens to a few hundreds of megavolts-per-meter. This means in turn that plasma-based accelerators can be built much more compact and cost-effectively, since the acceleration lengths required to reach a certain electron energy can be orders of magnitude shorter. For example, a target electron energy of 10 GeV can be reached after 1 m in a plasma with an effective accelerating field of 10 GV/m, whereas an acceleration length of 1 km would be required in a conventional accelerator based on metallic cavities with an accelerating field of 10 MV/m. For example, it has been demonstrated at the Stanford Linear Accelerator Center that an electron beam with an energy of 42 GeV, which required a conventional radiofrequency-cavity based acceleration distance of about 3 km, was energy-doubled to an electron energy of 84 GeV in a subsequent plasma accelerator of less than 1 meter length.

Plasma acceleration is based on the excitation of a longitudinal plasma wave by highly intense laser, electron or proton driver beams. Here, the driver beam expels the negatively charged electrons away from the driver beam propagation axis, while the positively charged, much higher-mass ions (mₚ/mₑ≈2000, where mₚ and mₑ are the proton and electron rest mass, respectively) remain quasistationary on the relevant timescales (femtosecond to picoseconds). Next, the plasma electrons which have been previously expelled from axis by the driver beam are re-attracted to the axis by the electric force exerted by the positively charged plasma ion background. This happens after a characteristic period of time, namely the plasma wave period τ=2π/ωₚ, where ωₚ=(nₑe²/(ε₀ mₑ))^{1/2} is the plasma frequency and nₑ, e, and ε₀ are the plasma electron density, the electron elementary charge and the vacuum permittivity, respectively. The plasma oscillation or blowout is co-propagating in the wake of the driver beam with a velocity typically very close to the vacuum speed of light c. The size of the longitudinally propagating plasma wave cavity scales approximately with the square root of the plasma electron density. Therefore, cavity size as well as the accelerating and focusing fields within the cavity can be tuned by changing the plasma electron density. In order to produce the plasma medium, either the driver pulse front can be intense enough to ionize neutral gas, for example as ejected by a gas jet nozzle or a plasma oven, or the ionization is provided by other auxiliary means such as by an additional ionization laser.

The initial stage of any acceleration process is crucial as regards the quality of the produced electron beam. The injection of electrons into the accelerating plasma cavity is therefore of paramount importance and is a highly active research field. Electrons can be either injected as external beams, for example coming from a conventional electron gun, or electrons from the background plasma itself can be used. For example, self-injection and trapping of those electrons which form the high-density cavity sheath can happen at the end of the plasma cavity blowout. Alternatively, density transitions which locally change the plasma wavelength can lead to enhanced and locally confined injection and trapping. In another method, two laser pulses are used, the one acting as pump pulse which generates the plasma wave, and the other acting as auxiliary pulse which alters the trajectory of oscillating plasma electrons in order to facilitate injection. In a further method, a subsequent, collinear laser pulse, with higher intensity when compared to the pump pulse, is used to further ionize additional stages of the plasma ions and produces electrons. However, these electrons have large transverse momentum, since the second laser pulse needs to have an even higher intensity than the first laser pulse, the one which drives the plasma wave, in order to set free additional electrons via ionization of higher ionization stages. Therefore, the released electrons gain large transverse momentum in the strong transversal oscillating electric field of the second laser pulse, which is unwanted because this increases the phase space volume of the injected and released electrons.

It is also known that a combination of gas species can be used for enhanced injection in such a way that the front of the high-intensity laser pulse driver ionizes one gas species and sets up a plasma wave, and the main part of the laser pulse, where the intensity is highest, ionizes gas species with a higher ionization threshold, producing electrons that have a better chance of being trapped and accelerated in the accelerating phase of the plasma blowout.

All these methods are substantially advanced when compared to rather poorly controllable self-injection, but they share the feature of the injection laser pulse being of rather high intensity. This means that the injected electrons receive a rather large transversal momentum right from the start, which limits the obtainable divergence and emittance of the accelerated electron bunch.

Therefore, there is a need for a controllable method capable of generating highly compact, ultracold and shapeable electron beams with transversally low momentum, which characteristics are highly desirable for advanced light sources such as free-electron lasers, for example.

### BRIEF SUMMARY OF THE INVENTION

The present invention provides a novel plasma-based method and apparatus, wherein a low-intensity laser pulse is used to release electrons in a highly controllable way with extremely low transverse momentum directly in the accelerating and focusing phase of an electron-beam driven plasma blowout. This enables the controllable production of shapeable electron beams with ultralow emittance. These beams are highly suitable to drive Free-Electron-Lasers to generate ultrabright x-rays with wavelengths down to the sub-Angstrom-regime in conventional or superconducting undulators, and to generate coherent enhanced hard x-rays in a plasma wiggler and undulator in an all-optical setup. The invention therefore addresses the need for compact and superior radiation sources of coherent hard x-rays.

In a first aspect of the inventive method, a plasma blowout cavity generated in the wake of a dense particle beam, preferably an electron or proton beam, is used to provide ideal accelerating and focusing electric fields to produce and accelerate an electron beam with ultracompact size and ultralow emittance. These electrons are released on and close to the propagation axis by a low-intensity injection laser, which is focused inside the blowout in space and time with an intensity just above the ionization threshold of a low-ionization threshold species such as alkali metals, or rare gases such as helium.

In an important feature of the electron beams generated in this way, the electron beams are then used to drive a Free-Electron-Laser by oscillating and microbunching when passing through a magnet-based undulator.

In a second aspect, the injection laser beam ionizes electrons off axis, which leads to enhanced betatron oscillations of the electrons within the blowout, thereby generating bright and hard light down to the x-ray or even gamma-ray regime.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a schematic diagram illustrating the physical mechanism of laser-driven plasma wakefield acceleration. The laser pulse (moving to the right) expels electrons off axis, which then form the plasma blowout cavity shape and a reattracted by the quasistatic ions.

FIG. 2 shows the electric longitudinal field generated by the transient charge separation of electrons and ions of the laser-driven plasma blowout.

FIG. 3 shows the electric longitudinal field generated by the transient charge separation of electrons and ions in case of a particle-beam driven plasma blowout.

FIG. 4 shows the radial electric field generated by electron particle bunches as a function of distance from the bunch center. This radial field is mainly responsible for ionization during its passage through unionized media.

FIG. 5 shows the ionization probability rates based on Ammosov-Delone-Krainov (ADK) theory for various species which are especially important for the present invention.

FIG. 6 shows how a laser pulse releases electrons via ionization within the beam-driven plasma wave blowout in accordance with the present invention.

FIG. 7 illustrates that the electrons released by the laser pulse within the blowout are trapped inside the second half of the blowout, where the longitudinal electric field is accelerating.

FIG. 8 shows that electrons can be released off axis in a highly controllable way, if the laser pulse is parallel to the axis, but has a transversal offset. This way, highly controlled betatron oscillations of the laser can be triggered, which can then be used for the production x-ray radiation.

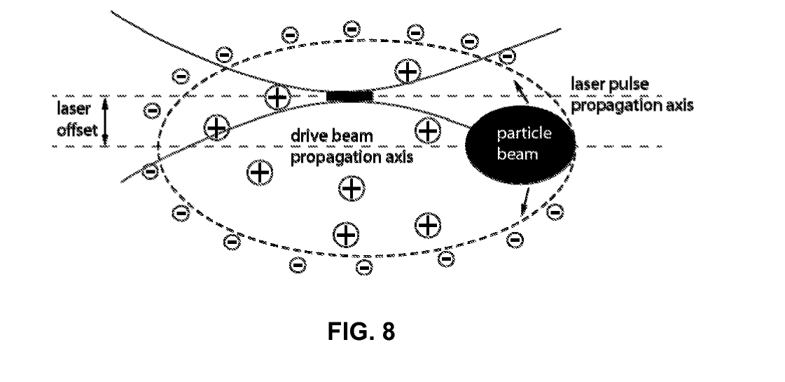

FIG. 9 shows that advanced electron beam shaping can be done via injecting the laser pulse at an angle α to the drive bunch propagation axis, which can be used for advanced electron bunch shaping.

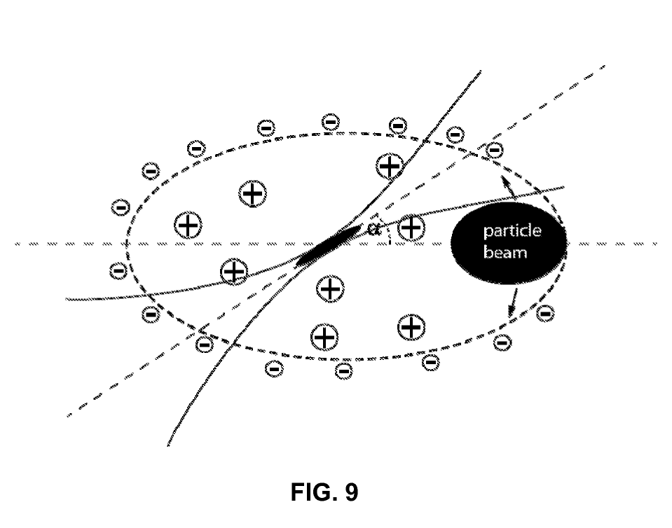

### DETAILED DESCRIPTION OF THE INVENTION

In conjunction with the figures, preferred embodiments of the inventive method are described that utilize a compact and relatively inexpensive laser-plasma-based system to generate tunable electron and light beams of highest quality.

Laser-driven plasma accelerators which produce compact quasi-monoenergetic electron bunches are today state-of-the-art. Laser technology suitable to generate high-power laser pulses is today available as off-the-shelf products, and even complete high-power laser systems with powers of hundreds of TW are commercially available. Such systems have a footprint of few square meters, only, and are obtainable at comparatively low costs. Therefore, laser-plasma-accelerator facilities are mushrooming all over the world as versatile particle accelerators. They can be used to produce compact electron bunches with durations and widths of a few femtoseconds, only, and bunches with energies up to more than a GeV have already been demonstrated.

The typical implementation of laser wakefield acceleration (LWFA) of electron bunches is as follows: A 100 TW-class high-power laser pulse driver based on Ti:Sapphire technology, for example with a pulse duration of 30 fs and an energy of 3 Joules, is focused to a spot size of a few micrometers squared into a gaseous medium, yielding laser pulse focus intensities of the order of 10¹⁸-10¹⁹ W/cm². Here, the front of the laser pulse immediately ionizes the gas (intensities in the 10¹⁴-10¹⁵ W/cm² range would already be sufficient for this), generating a plasma. Next, the oscillating transversal electric field of the laser pulse expels electrons off axis, leaving behind a region fully cavitated of electrons. The high intensities of 10¹⁸-10¹⁹ W/cm² are necessary mainly because this electron cavitation should be effective. The ions, being four orders of magnitude heavier than the easily movable electrons, are left behind as a quasistationary, positively charged background. This ion background reattracts the electrons which have been previously expelled off axis.

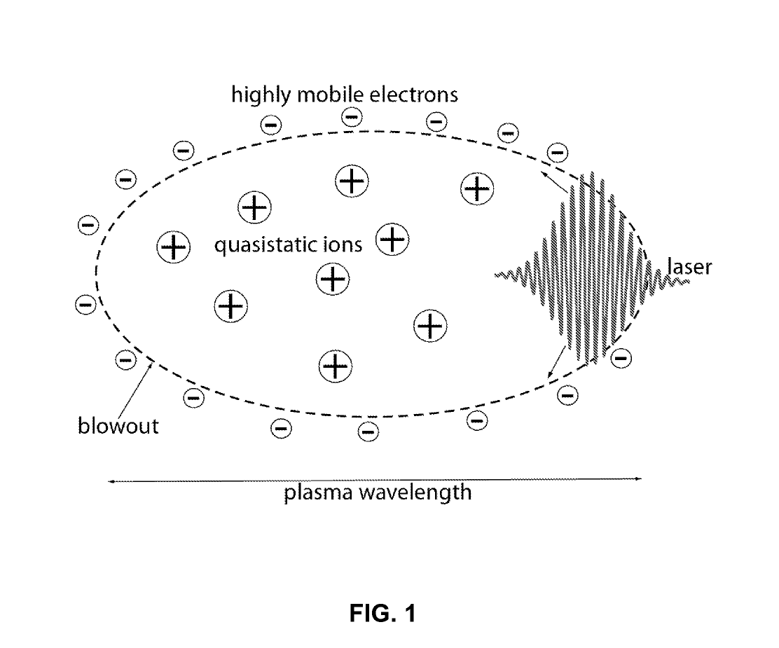

FIG. 1 shows schematically, how a high-intensity laser pulse generates transient separation of electrons and ions by expelling electrons off its propagation axis. The geometry and dynamics of the forming transient plasma structure is governed mainly by the plasma electron density nₑ. The length of the plasma electron blowout, for example, is approximately the plasma wavelength λₚ=2πc/ωₚ=2πc (nₑe²/(ε₀ mₑ))^{-1/2}. This length is dependent only on the electron density nₑ, which in case of laser-plasma-accelerators typically is in the range of 10¹⁷-10¹⁹ cm⁻³. In this density range, the corresponding plasma wavelength λₚ amounts to 10-100 μm, only. The length can be elongated in case of particularly intense drivers, because then relativistic mass increase may set in. The plasma blowout moves through the plasma in the wake of the driving laser pulse with the same speed as the laser pulse driver. Via the charge displacement which forms the blowout, the transversal, oscillating electromagnetic field of the laser pulse is used to produce a longitudinal electric field in the plasma blowout which is highly suitable for acceleration of electrons. While within the whole blowout, transversally focusing electric fields are present, in approximately the first half of the blowout the electric fields are decelerating, and in the second part the electric field is accelerating.

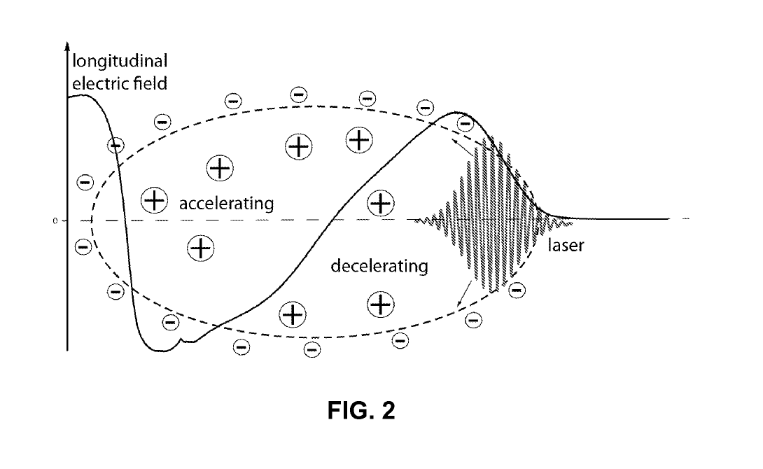

FIG. 2 shows a lineout of the longitudinal electric field and its relation to the plasma blowout. The accelerating and focusing second part of the plasma is highly suited to accelerate electrons, because here, the accelerating and focusing fields can reach many GV/m (gigavolts per meter). Therefore, in principle, electron accelerators based on laser-driven plasma wakefield acceleration can be orders of magnitude more compact when compared to conventional radiofrequency-based accelerators, where the electric fields are limited to the order of tens of MV/m (megavolts per meter). In addition, the compact size of the accelerating plasma blowout cavities imply that the accelerated electron beams do also have extremely compact longitudinal and transversal size down to the sub-μm level. Also, it is possible to generate electrons beams which are then accelerated in the plasma wave by the laser-plasma interaction itself, thus combining a cathode and injector with the accelerator section. These are the main virtues of laser-plasma-accelerators. However, there are also major limitations of laser-plasma-accelerators. The most serious ones are the injection of electrons into the accelerating phase of the blowout, and a limited energy gain due to diffraction of the laser pulse, and dephasing of the accelerated electrons with regard to the driving laser pulse.

The present invention provides a solution to all of these three major limitations, by using a novel hybrid scheme which employs a particle beam instead of a laser pulse to drive the plasma wave, and a synchronized, comparably low-intensity laser pulse to release electrons directly at arbitrary positions of the plasma blowout.

As regards injection of electrons into the blowout, one possibility is to use externally generated electron beams from a conventional device and to post-accelerate them in a plasma wave. Another is to use various techniques aiming at injecting electrons from the plasma itself into the plasma wave, and to produce a “quasi-monoenergetic” bunch during the laser-plasma interaction process. Among these state-of-the-art techniques for ameliorating and stabilizing the laser-plasma-generated-generated electron bunch characteristics are colliding pulse injection, ionization-assisted injection and density-transition injection. However, in all these schemes the plasma electrons are necessarily all previously perturbed by the high-power, high-intensity laser pulse driver. The driving laser pulse expels electrons off axis by virtue of its ultrastrong transversal oscillating electric fields in order to form the plasma blowout in the first place. The maximum laser fields which eject electrons transversally from the axis are even higher than the plasma fields, which means that the electrons which later, after they are driven back on axis by the remaining, quasistationary ions, and are then eventually trapped, already received a substantial amount of transverse momentum. This translates into a rather large divergence and emittance of the forming electron beam.

It is a fundamental characteristic of a focused laser pulse to diffract in vacuum, according to Gaussian beam optics. The focus length of a Gaussian laser beam can be approximated by the so called Rayleigh length Z_{R}=πω₀²/λ, where λ is the laser wavelength and ω₀ is the Gaussian beam waist. If focused to a beam waist of ω₀=5 μm, for example, the Rayleigh length amounts to approximately Z_{R}≈100 μm, only, for a Ti:Sapphire laser pulse with a central laser wavelength of 0.8 μm. This fundamentally limits the obtainable acceleration length and thus the energy gain from laser-plasma-interaction, although in a plasma self-focusing effects such as relativistic self-focusing can extend the focus length over several Rayleigh lengths. In order to extend the propagation length even more, preformed transversal plasma density profiles can be used, in order to change the index of refraction. Such a transversal plasma density profile has to be tailored such that it cancels out the Gaussian diffraction of the laser pulse. Preforming plasma channels with and additional laser pulse or gas discharges in capillary waveguides can be used for this. With these methods, acceleration lengths of several cm have been demonstrated with laser-plasma-accelerators, resulting in maximum energy gains of the order of 1 GeV.

As regards dephasing, another fundamental problem is that electrons reach a velocity very close to the speed of light in vacuum c very quickly (approximately at an electron energy of 1 MeV), whereas the laser pulse travels with a group velocity v_{g}<c in plasma. Therefore, the injected and accelerated electrons move forward within a laser-driven plasma wave blowout, which means that their position is shifted towards a decreasing longitudinal accelerating field, which reaches zero approximately in the middle of the plasma blowout, and then turns into a decelerating field. This characteristic of laser-driven plasma acceleration fundamentally limits the useful acceleration distance and thus, the energy gain of the electrons. Because the laser pulse group velocity is dependent on plasma density, working at lower plasma densities increases the dephasing length. Although lower plasma densities also result in larger blowout sizes and lower effective accelerating electric fields within the blowout, the overall scalings dictate that the overall energy gain can be increased by working at lower plasma densities.

Another possibility to increase the dephasing distance is to use longitudinal plasma density profiles. By increasing the longitudinal plasma density during the interaction, the blowout contracts, and the accelerating electrons which move forward within the blowout experience an accelerating electric field over an extended distance. However, both strategies, working at lower plasma densities and using longitudinally tapered density profiles aggravate the diffraction problem, since then the focus size has to be maintained over an even longer distance. Although a lower plasma density and a correspondingly larger plasma blowout allow for using softer focusing and a larger spot size ω₀ of the laser pulse, and therefore for an increased Rayleigh length and in principle, for a longer acceleration length, a larger focal size does in turn also mean that more energy is needed per laser pulse to reach the necessary high intensities to drive the plasma wave. Therefore, higher laser powers and therefore larger and more costly laser systems are needed, which is unwanted from a practical point of view.

Particle beam drivers can also be used in order to excite a plasma wave. When instead of a laser pulse driver, particle beam drivers are used to excite the plasma blowout, the dephasing and diffraction problems are substantially alleviated. A relativistic electron beam, for example, propagates at approximately the vacuum speed of light both in a plasma and in vacuum. Therefore, the driving electron bunch and accelerated electrons are both moving with approximately ˜c and no significant dephasing occurs even on meter-scale distances. In addition, a relativistic electron bunch with small divergence and physical emittance does not diffract as quickly as a laser pulse. The elimination of these two drawbacks connected with laser pulse drivers (dephasing and diffraction) make electron bunches superior drivers for plasma wakefield acceleration.

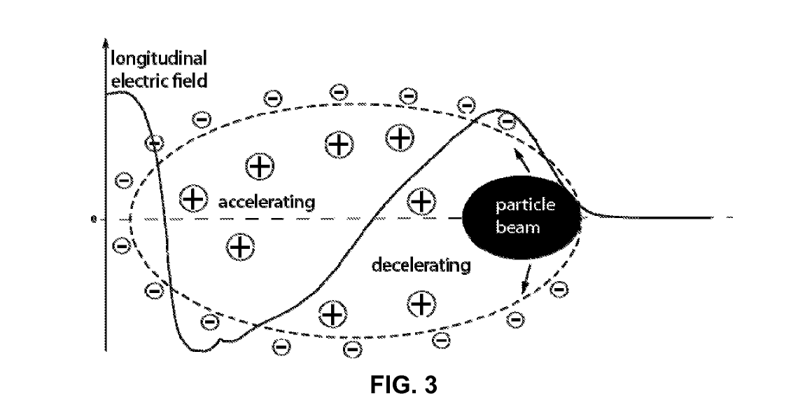

FIG. 3 shows schematically, how an electron beam driver beam drives a plasma blowout based on its unidirectional transverse fields. However, while focused state-of-the-art high-power laser pulses with intensities up to 10²¹ W/cm² or more do easily have electric fields which are able to ionize gases and to form a plasma blowout, electron beam drivers have to be extremely compact in order to have electric self-fields high enough to drive a plasma blowout, and even more demanding, to ionize matter.

Up to today, the only electron bunch in the world generated via conventional radiofrequency-based cavity technology which is intense enough to ionize at least a low-ionization threshold gas such as lithium is the one at the Stanford Linear Accelerator Center SLAC. This beam has paved the way in breakthrough experiments to enable energy doubling of 42 GeV electrons in a metre-scale beam-ionized lithium vapor and demonstrates the excellent suitability of electron drivers for plasma acceleration. The key factor for making this beam-driven plasma acceleration experiment possible was the highly advanced and complex electron beam length compression techniques involved, which resulted in compression of beam length to about 50 fs, an unprecedented value for an electron beam generated via conventional radiofrequency-cavity based technology.

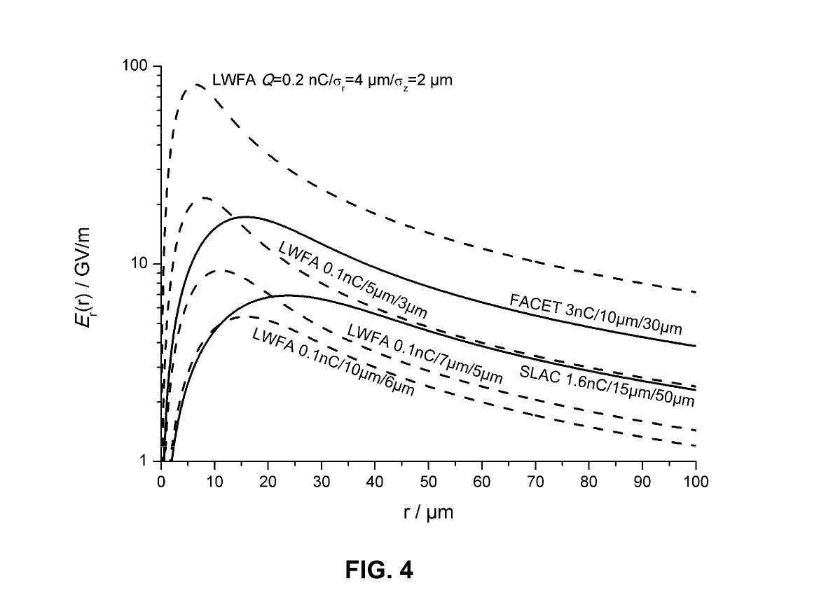

One of the most intriguing advantages of laser-plasma accelerators, on the other hand, is that they inherently produce extremely compact electron bunches, which are even an order of magnitude shorter than the beam at SLAC. Although typically having lower charge (typically a few to few hundreds of pC), these laser-generated bunches therefore have the potential to self-ionize low-ionization-threshold gases such as lithium and even medium-ionization-threshold gases such as hydrogen. This is because the radial electric self-fields of electron bunches scale very favorably with the bunch size. The radial electric field of a Gaussian-shaped electron bunch can be expressed as Eᵣ(r)=Ne/[(2π)^{3/2}σ_{z}ε₀r][1−exp(−r²/(2σᵣ²))], where σᵣ is the transversal beam size, σ_{z} the longitudinal beam size and Q=Ne the charge of N electrons. This value can approach the 100 GV/m regime for laser-generated bunches, as is shown in FIG. 4. The solid lines correspond to experimental cases at SLAC and at FACET, the Facility for Advanced aCcelerator Experimental Tests, whereas the dashed lines correspond to electron bunches based on values of charge and size similar to those measured in laser-plasma-accelerator experiments. This illustrates that laser-plasma-accelerators can also be sources for highly compact electron bunches which can be used as plasma drivers for beam-driven plasma accelerators. This is highly advantageous, since laser-plasma-accelerators are mushrooming all over the world, with currently about fifty systems installed worldwide, steadily increasing in number and power. Therefore, the number of available accelerator systems with the potential to produce electron bunches capable for self-ionizing beam-driven plasma wakefield acceleration to high energies is increased dramatically by nearly two orders of magnitude and will continue to rise in the future. Due to continuing progress of accelerator technology, there are also further non-plasma-based accelerators coming online currently in the future which are able to deliver self-ionizing electron beams, for example FLASH at DESY in Germany.

Even if electron bunches are not compact enough or do not have enough charge to self-ionize gaseous media by virtue of their electric self-fields, they can nevertheless be used to drive plasma waves in preionized media. Unless with laser pulse drivers, where the capability to field ionize gaseous media sets in at focus intensities many orders of magnitude lower than the intensities which are needed for driving a plasma wave, with electron beam drivers there is a large parameter regime where the beam's intensity is sufficient to drive a blowout in a plasma medium, but would not be able to ionize the medium itself based on its self-fields. The reason for this is that the transversally oscillating fields of laser pulses are by far less suited to eject plasma electrons off axis when compared to the unidirectional transverse fields of particle beams. While the threshold of the capability to field ionize is given by the inherent atomic characteristics of the gaseous species which shall be used to constitute the plasma wave, the capability to drive a strong plasma wave is given by Rosenzweig's “blowout criterion” n_{b}>nₑ, where the electron density of a transversally and longitudinally Gaussian bunch is n_{b}=N/(2π)^{3/2}σᵣ²σ_{z} and N is the number of electrons in the bunch. The plasma must be “underdense”, which means the driver beam electron density n_{b} has to be larger than the background plasma nₑ. Therefore by decreasing the plasma density, one can reach the blowout regime and can still drive a strong plasma wave.

Preionization of the plasma can be done either with laser pulses which precede the plasma wave driver laser pulse, or via discharges in capillaries, for example. In laser-plasma-interaction, capillary discharges are often used in order to generate a transversal density profile. Capillary discharges have also been already used to provide a plasma for electron-beam driven plasma wakefield experiments, for example at the Brookhaven National Laboratory (BNL). Therefore, by using preionization and a bunch density/background plasma ratio which allows for driving a blowout, one can enable electron bunches to act as plasma wave drivers. This further increases the number and availability of electron sources which can be used for bunch-driven plasma wakefield experiments.

The problem of injection persists with bunch-driven plasma wakefield accelerators as well as with laser-driven plasma wakefield acceleration. This invention provides a method of injection of electrons into high-density beam-driven plasma waves which generates electrons with ultra-small transverse momentum and divergence. The electron bunch is accelerated quickly to large energies and thanks to its unprecedentedly small transverse emittance can then be used ideally for applications such as driving free-electron lasers, for Thomson scattering, or for direct production of hard light, or for collider experiments. These applications which are enabled by the present invention are of extreme importance for basic physics, but also for material science, biology and medicine. The particle bunch driver used to set up the plasma wave can come either from a laser-plasma-accelerator, or from non-plasma-based accelerators.

The particle bunch which is used in the present invention shall use species with an especially low ionization threshold to drive a plasma wave. This way, the length over which the plasma wave can be driven by the expanding beam, and thus the energy gain, can be maximized. Ideal species for this are alkali metals such as lithium, rubidium and cesium, which have first ionization potentials of 5.39 eV (Li), 4.18 eV (Rb), and 3.89 eV (Cs).

If the driver bunch is compact enough and has sufficient charge, it will have large enough electric fields to ionize this ionization level. It shall, however, not be compact enough to ionize also higher ionization levels. Therefore, these higher ionization levels are still left and ready for ionization uniformly within the medium. These unionized levels are needed for controlled release of electrons.

As a key feature of the present invention, a synchronized and focused laser pulse shall now be used to ionize one or more of the higher ionization levels, which are not affected by the driver electron bunch, at arbitrary position within the plasma blowout. This releases electrons directly within the blowout at arbitrary positions, which therefore constitutes a paradigm change when compared to state-of-the-art injection techniques.

These higher ionization levels can be preferably, and without loss of generality, the second ionization levels of the alkali metals Rb (27.28 eV) or Cs (25.1 eV) or additional gas components such as helium (first ionization potential 24.6 eV). Helium is often used in alkali metal vapor ovens as buffer gas, for example at SLAC. In principle, also other species, or combinations of species, for example mixtures of Rb/Cs/Li/He, or even species which are gaseous at ambient conditions and therefore do not require plasma ovens, such as oxygen, nitrogen, neon, argon can be used. This holds both for the low and the ionization levels.

It is important, however, that there is a substantial gap between the low and the high ionization levels, so that the driver particle bunch does ionize only the low ionization level, but not the higher levels, over an extended acceleration length. Because of the finite divergence and emittance of particle beams, the transversal bunch size grows during their passage through the plasma. Because of the finite emittance of the driver beam, the optimum configuration is to have the driver configuration of charge, length and width such that its electric fields are initially just a bit smaller than what would be needed to ionize the high ionization levels involved, so that the acceleration length is maximized. Due to the finite emittance, the bunch size will increase over time, and the electric self-field will decrease. This, in turn, reduces the ability of the bunch to self-ionize, and the ability to self-ionize the lower ionization level will be lost sooner or later during the interaction.

If the driver bunch is not compact enough and does not have sufficient charge to self-ionize the low-ionization level, pre-ionization can be used. This can be either laser-based pre-ionization or capillary discharge-based. Pre-ionization shall ideally affect only the low ionization level, not the high ionization level(s). For example, when using a laser pulse or multiple laser pulses for pre-ionization, either axicons or very soft focusing (i.e., long Rayleigh lengths of the order of a few millimeters up to the meter-scale) is used. This way, it can be made sure that the effective laser intensity is high enough to ionize the low ionization level effectively, but does not ionize the higher ionization level which is needed for electron release.

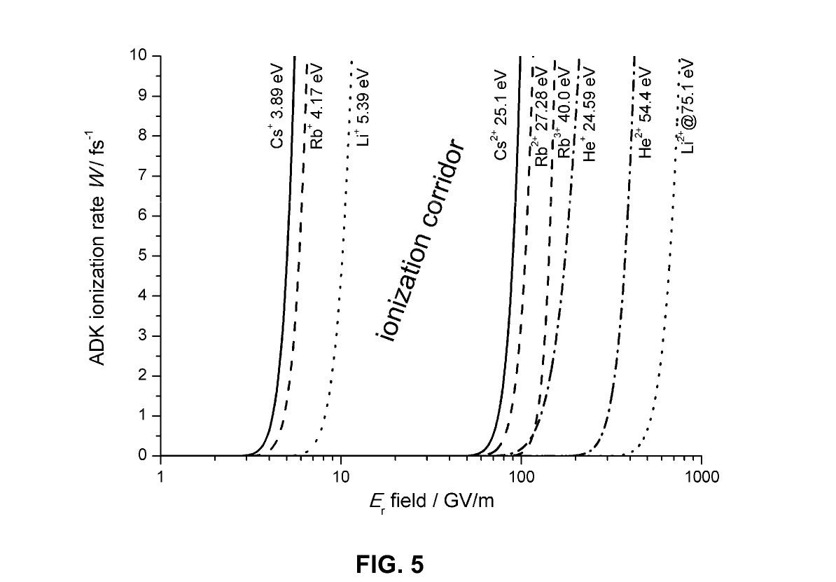

Pre-ionization can be done with a Ti:Sapphire laser with a central wavelength of at λ=0.8 μm. At an intensity of about 7×10¹⁴ W/cm², for example, the first ionization levels of cesium, rubidium and lithium are ionized via field ionization, while the second ionization level of Cs, the second and third ionization level of Rb and the first ionization level of He are not field ionized. Using the dimensionless light amplitude a₀=eE/(m₀ωc), where e is the elementary charge, E is the electric field amplitude, m₀ is the electron rest mass, ω is the laser frequency and c is the speed of light, one can express the laser intensity I as I=2a₀²ε₀c(π mₑc²/(eλ)²≈a₀²/(λ² [μm²])×1.37×10¹⁸ W/cm². The a₀ factor describes the transition from the non-relativistic (aₒ<1) to the relativistic regime (a₀>1), where the oscillation of electrons in the focused laser field is strong enough to cause relativistic mass increase and substantially alter the laser-matter interaction. Using this dimensionless laser amplitude, the maximum electric field amplitude of the laser pulse is expressed as E₀=2πa₀mₑc²/(eλ)≈3.2×10¹² aₒ/(eλ² [μm²]) V/m. For an intensity of about I≈8×10¹² W/cm², the dimensionless light amplitude amounts to a₀≈0.002, only, and an electric field amplitude of E₀≈8 GV/m. The ionization probability rates can be expressed based on the well-known Ammosov-Delone-Krainov (ADK) model. FIG. 5 shows the ionization probability rates in dependence of the electric field for various species. The large ionization corridor between low ionization levels around 5 eV and higher ionization levels at around 25 eV are enabling factors to achieve large acceleration distances with electron bunch drivers. A light amplitude of a₀≈0.002 is already enough to ionize the first ionization levels of Cs, Rb and Li.

The next enabling component of the present invention is to use a synchronized, laser pulse of comparably low intensity to set free electrons directly within the plasma blowout based on the low-ionization level component, driven by the particle bunch driver. In order to release electrons via ionization of helium, for example, a Ti:Sapphire laser pulse with a pulse duration of 10 fs and an intensity of about I≈7×10¹⁴ W/cm², the dimensionless light amplitude of which amounting to a₀≈0.018, and corresponding to an electric field amplitude of E₀≈72 GV/m is sufficient (compare again FIG. 4 and FIG. 5). This is an intensity which is about three or four orders of magnitude lower than what is used for state-of-the-art laser plasma acceleration schemes, and this translates directly to the electron divergence and emittance.

In contrast to the pre-ionization laser pulse(s), which need soft focusing and long Rayleigh length in order to ionize the low ionization level over an extended length, the electron release laser shall use strong focusing and short Rayleigh length, of the order of tens of microns. The synchronized, low-intensity laser pulse shall have an intensity which just in its focus should slightly exceed the ionization threshold. In combination with the short focal length, this makes sure that high ionization level electrons are only released in an arbitrarily small volume.

The total charge released by the synchronized release laser can be tuned by varying the laser intensity via laser pulse energy variation or via laser focusing, by varying the laser pulse duration, by tuning the plasma density of the higher ionization level species, or by combinations of these parameters.

For example, a mixture of cesium, rubidium and helium can be used, where the first ionization thresholds of cesium and rubidium provide the plasma density needed for the driver bunch in order to set up the blowout, and the second ionization level of cesium, the second and third ionization levels of rubidium, and the first ionization level of helium are all used to provide electrons which are then released in the blowout to form the new electron beam. When compared to using a mixture of lithium and helium, this means that the released electron charge is accordingly increased. The density of the gaseous components cannot easily be tuned independently from each other, but are dependent on their individual vapor pressures. Furthermore, in the standard configuration of an alkali metal oven, helium is used as a buffer gas which comprises the alkali metal vapor within, so that in the longitudinal propagation direction there is a region where there is predominantly helium, followed by the inner alkali metal section, and another helium section. The transition between each region is not abrupt, but can extend over millimeters or centimeters. So the first transition from helium to the alkali metal is characterized by a slowly decreasing helium density, while at the same time the alkali metal vapor density increases. Analogously, the slow decrease of alkali metal density at the end of the alkali metal vapor section is accompanied by an increase of helium buffer gas density.

In a first-order approximation, the upper limit of the total charge of the electrons released by the release laser inside the blowout can be approximated by assuming that all electrons from species for which the focal laser intensity exceeds the ionization threshold are released by the laser pulse. The focal volume can be approximated by a cylinder with a length the same as the Rayleigh length Z_{R}=πω₀²/λ, where λ is the laser wavelength and ω₀ is the Gaussian beam waist, and an area of A=πω₀². The focal volume therefore is V=Z_{R} A=π²ω₀⁴/λ, in case of a Ti:Sapphire laser pulse with a central laser wavelength of λ≈0.8 μm focused down to ω₀=3 μm, for example, amounting to approximately V≈1×10⁻¹⁵ m³=1×10⁻⁹ cm³. Assuming, for simplicity, a system consisting only of cesium, where the first ionization level at 3.89 eV provides electrons for the accelerating plasma blowout, and the second ionization level at 25.1 eV is used to provide electrons which are released inside the blowout by the release laser, the total released charge can be calculated as follows. For example at a reasonable cesium density of n=4×10¹⁷ cm⁻³, the drive bunch would have expelled all the first ionization threshold electrons of cesium, having generated a plasma blowout with a plasma wavelength of λₚ≈52 μm, corresponding to an electron density of nₑ=4×10¹⁷ cm⁻³. Now Cs⁺ ions are present inside the plasma blowout, being ready to release another electron per ion at the 25.1 eV potential. Based on the above approximated laser focal volume V, for a laser operating just above the ionization threshold intensity this means that nₑ×V≈4×10⁸ electrons can be in principle released, corresponding to a total charge of Q≈65 pC.

Using this approximation, the total released charge scales linearly with the plasma density nₑ, and the fourth power of the laser beam waist ω₀. That means that in order to increase the released charge, increasing the laser pulse beam waist is most efficient. However, increasing the beam waist also increases the initial phase space volume and thus, the minimum emittance to be obtained. On the other hand, increasing the initial volume of electrons initially does not increase the electric Coulomb forces which can generate additional transverse momentum, which in turn would increase the emittance, whereas in contrast increasing the plasma density would increase the electric transverse Coulomb forces. Second, increasing the laser pulse focal waist also increases the Rayleigh length, and thus the length of the column where the laser releases electrons inside the blowout. In fact, the Rayleigh length can become longer than the plasma wavelength. In this case, electrons at the end of the focal volume are no longer being trapped and accelerated inside the blowout, but slip through the blowout end to the second blowout formed by the plasma wave behind the first one, where they may or may not be trapped and accelerated. Although this process may be used to produce electron multi-bunch trains, these electrons do in any case not contribute to the charge of the main bunch formed in the first blowout. Generally speaking, the Rayleigh length should not exceed the plasma blowout length in order to make it possible to trap all the released electrons, it should rather be of the order of the hald blowout length, i.e. Z_{R}≈λₚ/2.

Ionization defocusing is likely to happen to the laser pulse during the release process. This is because the electron density on axis, where the laser intensity is maximum, is higher than off axis. This leads to a transverse electron density distribution where the electron density decreases when farther off axis, which in turn has repercussions on the index of refraction of the laser pulse. This well-known phenomena can therefore lead to increased diffraction of the laser pulse, and thus to a decreased length of the ionization column. This can be helpful in what regards enhanced confinement of the electron release region inside the blowout, on the other hand it can also decrease the total charge released.

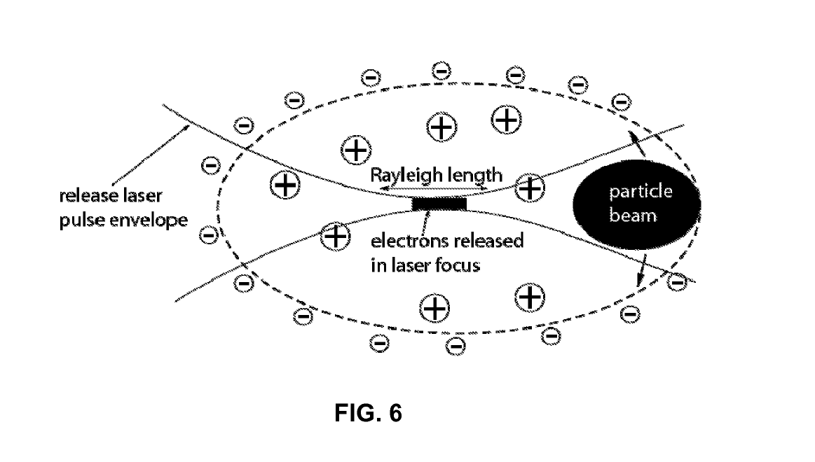

The above approximation that electrons are released in the whole laser focal volume as defined by the Rayleigh length and the focal width of the laser pulse does not take into account the time dependence of the ionization. As shown in FIG. 5, the ionization does not take place instantly, but instead will require a finite amount of time. The ionization rates as displayed in FIG. 5 show that therefore the degree of ionization is dependent on the duration of a laser pulse. A laser pulse which is 5 fs long, for example, will release much less electrons than a laser pulse which is 10 fs long. Tuning the duration of the laser pulse therefore provides an additional means of tuning the charge released within the blowout. The duration of the laser pulse τ, however, should normally be shorter than the accelerating plasma blowout's wavelength, i.e. τc<λₚ. This way, it is made sure that most electrons released by the laser pulse are born inside the blowout, and second, it is made sure that the laser pulse oscillating field does not interact strongly with neither the drive bunch nor the blowout shell during passing the laser focus. For example at a plasma density of nₑ=4×10¹⁷ cm⁻³, the plasma wavelength and the blowout length approximately amount λₚ≈52 μm. In this case, a laser pulse of full-width-half-maximum duration τ≈λₚ/2c≈86 fs (half as long as the plasma blowout), synchronized such that the laser pulse center is coincident with the center of the plasma blowout, as shown in FIG. 6, will release electrons mainly in the center of the blowout, but the region of electron release will also extend into the first half, as well as in the second half of the blowout. At the same time, the laser pulse does not interact significantly with neither the driver bunch nor the vertex of the blowout, nor the blowout shell at the moment it is focused to full intensity.

On the other hand, having the injection laser pulse interfere with the released and trapped electrons, can be advantageous because the transversally oscillating fields can imprint a microstructure on the electrons in the back of the blowout during the early moments of acceleration. It is a claim of the present invention to achieve this by increasing the length of the laser pulse, for example, or by tuning the delay between driver bunch and release laser pulse, or a combination of both. Here, it is important that on the one hand the laser pulse group velocity β_{g,l}=(1−nₑ/n_{c})^{1/2}, where nₑ is the electron plasma density and n_{c} is the laser wavelength-dependent critical density, is initially higher than the velocity of the electrons which are released and accelerated, but that the electrons which are accelerated soon reach a velocity which is larger than the laser's group velocity in plasma. However, aside from the electrons released in the moment when the laser pulse reaches its focus, the blowout is electron-free, which increases the laser pulse group velocity so that it can travel at approximately the same speed as the accelerated electrons for an extended period of time within the blowout.

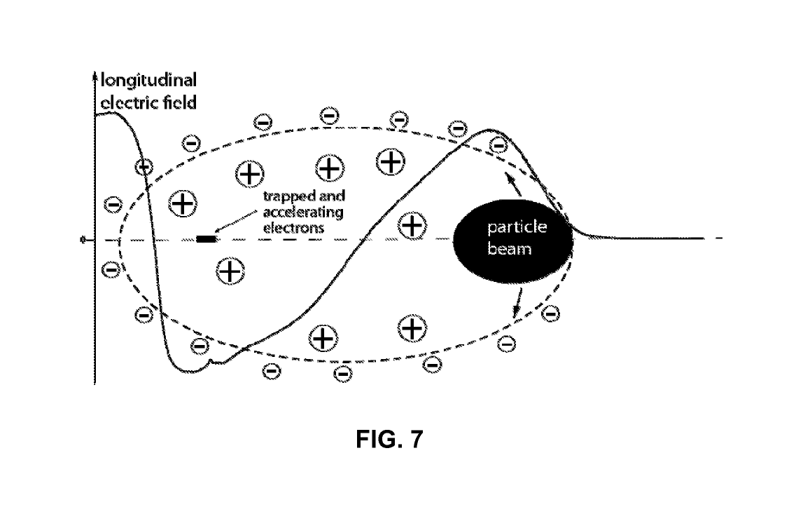

Electrons both in the first half of the blowout, where the longitudinal electric field is decelerating, as well as in the second half, where the electric field is accelerating, can be trapped and accelerated. The absolute value of the longitudinal electric field is small close to the center of the blowout, as shown in FIG. 3. Electrons released by the laser pulse initially have approximately zero longitudinal momentum. Being initially at rest, those electrons in the first part of the blowout do experience the decelerating field only for a very limited amount of time. This is because the blowout itself moves at a velocity close to the speed of light. Being left behind, the electrons will therefore soon experience the accelerating field in the second part of the blowout, which is increasing towards the end of the blowout. Therefore, electrons which are initially released in the first half of the blowout close to the center of the blowout at the turning point from accelerating to decelerating field will still be trapped at the end of the blowout, where the accelerating field is largest. Electrons which are released just behind the turning point of the plasma's longitudinal field are experiencing an accelerating field right from the beginning of their life. They will therefore be trapped and travel at relativistic velocities at a longitudinal position which is further upstream when compared to the position of electrons which are released in the decelerating half of the blowout. Since both the driver beam and the accelerated bunch will soon travel at relativistic speeds and there is no significant dephasing anymore, the steady-state position of the electrons with respect to the blowout's accelerating field is decisive as regards the experienced accelerating field during the main part of the acceleration process. Therefore releasing electrons in the first half of the blowout can actually be advantageous, since the final position with respect to the blowout is closer to the end of the blowout, where the electric field is maximum, when compared to the electrons released in the accelerating half of the blowout close to the center. Therefore the electrons initially released in the decelerating half of the blowout will gain a higher energy during the whole acceleration process. In contrast, those electrons which have been released just behind the turning point of the electric field in the accelerating part of the blowout will have a steady-state position where the accelerating field is lower, therefore allowing them only a lower energy gain during the whole acceleration process. Finally, electrons which are released at a later position within the blowout, where the accelerating field is higher, are trapped most quickly. These electrons might end up at the same steady-state position as electrons released in the first half of the blowout, therefore also gaining large energy during the whole acceleration process. Therefore, the front of the formed, trapped and accelerated electron bunch stems from electrons which have been initially released close to the turning point of the plasma longitudinal field, while electrons in the back part of the bunch may come from an initial release position in the first part of the blowout or from a release position further in the back of the accelerating part. The whole trapping process leads to a contraction of the released electron bunch to a length substantially shorter than the Rayleigh length of the release laser pulse. FIG. 7 illustrates how the released electrons fall behind and are then trapped in the accelerating part of the blowout.

Ionization electron release can be done preferably with Ti:Sapphire laser pulses at a wavelength of λ≈0.8 μm, because such laser pulses are readily obtainable and enable an easy path towards especially short pulses, but can also done at with lasers at other wavelengths, for example in the UV or in the far infrared.

The laser pulse can be polarized either linearly, circularly or elliptically. In case of linear polarization, the transverse electric fields oscillate in one plane, only. The initial transverse momentum of the generated electron bunch therefore will also be in this direction, only. Therefore the initial and ideally not space-charge increased emittance in the direction perpendicular to the laser polarization direction will be even smaller than in the polarization direction, which especially for low released charges will persist even until large (GeV-scale) energies. This is another important feature embraced by the present invention and is of high relevance for applications such as light sources.

The energy spread of the driving electron beam is relatively unimportant as regards its plasma wave driving capabilities. As long as the energy of the drive beam electrons is sufficiently relativistic (approximately >100 MeV), energy spreads of tens of percent can be easily tolerated, because all electrons nevertheless propagate with approximately the speed of light in vacuum. Therefore, no substantial dephasing occurs on the acceleration length scales of centimeters up to meters. For example, an electron with an energy of 400 MeV dephases from an electron of 500 MeV energy (25% higher energy than 400 MeV) only by 0.3 μm on a distance of 1 meter. Therefore, a high-energy electron bunch with large energy spread is in a first approximation similarly well suited to drive a plasma blowout over distances of tens of cm as an electron bunch with perfect energy spread: The electric self-field of the bunch is initially independent on the individual electron energy. For the present invention, the main desirable characteristic of the driving electron bunch is that it should be compact enough to have an electron density which evokes radial electric fields large enough to drive the blowout, and even better, to ionize the low-ionization species. This is in contrast to most other applications, where the electron energy spread should be as narrow as possible, which is one of the main objectives for conventional accelerators and laser-plasma-accelerators alike. The dramatically relaxed requirements put on energy spread for the present invention are of benefit to every accelerator source, but especially to laser-plasma-accelerators. Because of the inherent dephasing, injection issues and large fields, laser-plasma-accelerators typically produce electron bunches with large energy spreads, typically of the order of ten percent or more. It is very challenging to produce electron bunches with narrow energy spread from laser-plasma-accelerators, which nonetheless so far is one of the main tasks in that research field because most applications demand that. Because the driver beams for the present invention do not need narrow energy spreads, this is very advantageous because this challenging tasks disappears. For the present invention, the focus is put on higher charge and compactness, which is easier to accomplish than very narrow energy spreads.

Unlike in conventional photocathodes, where electric fields in the MV/m range accelerate the electrons emitted by the solid state cathode, in the present invention the electrons are accelerated, as well as focused, by GV/m scale electric fields. The electrons therefore gain energy very quickly and become relativistic. Since Coulomb expansion of an electron beam decreases as electron energy γ increases, where γ=(1−(v²/c²))^{-1/2}=(1−β²)^{-1/2}=(1+p/(m₀c))^{1/2} is the relativistic Lorentz factor, β is the ratio of electron velocity to vacuum speed of light c, p is the electron momentum and m₀ is the electron rest mass. The expansion force of the electron bunch scales as γ⁻², which is why it is extremely desirable to accelerate quickly so that space charge does not increase the bunch emittance much. The GV/m fields in the accelerating plasma blowout of the present invention therefore are of paramount importance in order to relativistically stabilize and minimize the bunch emittance, while at the same time producing ultrashort, high-density bunches.

It is an aspect of the invention that the blowout volume, where the electrons are released, is uniformly filled with ions based on the species which is used to produce the accelerating plasma blowout. Furthermore, the release of electrons due to ionization the higher-ionization species does at the same time produce additional positively charged ions on axis. These contribute additionally to screening the space charge forces of the negatively charged electrons after they are released. These ions are quasistationary, whereas the released electrons are quickly accelerated in the forward direction by the plasma blowout's electric field. That means that the ions produced by the release laser pulse are quickly left behind and therefore do only help screening the emittance-increasing space charge forces of the electron bunch in the first part of the acceleration. However, during this initial phase of acceleration, when the electron energies are still comparably low, the space charge force is most serious due to the γ⁻² scaling. Therefore the initial screening helps most. In an aspect of the invention, the Rayleigh length of the release laser on axis shall be maximized over the whole length of trapping positions. This way, especially electrons which are released in the back of the release laser pulse will profit most from the space charge screening, because they travel through an especially long ion column.

In addition to the space charge forces which are present and work on the produced electron beam, there is also a contribution by the laser which releases the electrons in the first place. An approximation of the laser contribution to the initial emittance in the laser polarization direction can be done via considering the initial area the electrons are released in, and the transverse momentum these electrons gain initially. If the laser pulse is focused down to a waist size of w₀, and the dimensionless light amplitude in the focus a₀ is just above the ionization threshold, it can be assumed that the initial transverse dimension of the electron source σᵣ is about σᵣ=w₀/2^{1/2}, and the transverse momentum gained in the laser field is about is about σₚᵣ/(mc)=a₀/2. The resulting normalized emittance then can be approximated to be εₙ≈σ_{r, He} σₚᵣ/(mc)≈w₀ a₀/2.8. For example, with a laser focal waist of w₀≈4 μm, and operating with a laser intensity I≈7×10¹⁴ W/cm² at the typical central wavelength of λ≈800 nm of a Ti:Sapphire laser (Table 1 shows the potential decrease in emittance when operating at shorter wavelengths, which is one further aspect of the invention) which corresponds to a₀≈0.018, the approximated minimal initial emittance in the polarization plane would be εₙ≈σ_{r, He} σₚᵣ/(mc)≈w₀ a₀/2.8≈2.6×10⁻⁸ m rad, only. This excellent value is at least one or two orders of magnitude better than what can be achieved with other approaches, and is one of the primary benefits of the present invention. Another is the extremely small bunch size, which allows to produce bunches with very high current even at low bunch charge. Low emittance and high current Iₚ are the key factors to realizing extremely high brightness of the electron beam, which is defined as B≈2 Iₚ/εₙ². For example at a peak current of Iₚ≈300 A, the brightness based on the above approximated normalized emittance amounts to of B≈2 Iₚ/εₙ²≈7×10¹⁷ Am⁻² rad⁻². Both beam emittance as well as beam brightness are at least one or two orders of magnitude better than with the LCLS in Stanford, where a high-brightness beam is used to drive the world's brightest Free-Electron-Laser (FEL). The emittance and brightness values obtainable with the present invention show that a dramatically brighter Free-Electron-Laser would be possible. Also, at an energy of 14 GeV, which could be reached after acceleration in a plasma with a length of about 0.5 m, the minimum wavelength which could be reached in an undulator would be λₘᵢₙ≈4πεₙ/≡_{LCLS}≈0.01 nm, about one order of magnitude harder than the current LCLS performance.

From the foregoing discussion, it will therefore be appreciated that the present invention has several novel features, which include but are not limited to the following:

1. The invention provides a method of injection of electrons into high-density beam-driven plasma waves which generates electrons with ultra-small transverse momentum and divergence.

2. The particle bunch which is used in the present invention uses species with an especially low ionization threshold to drive a plasma wave.

3. In the present invention, a synchronized and focused laser pulse is used to ionize one or more of the higher ionization levels, which are not affected by the driver electron bunch, at arbitrary position within the plasma blowout.

4. The present invention uses a synchronized, laser pulse of comparably low intensity to set free electrons directly within the plasma blowout based on the low-ionization level component, driven by the particle bunch driver.

5. The present invention achieves interference of the injection laser pulse with the released and trapped electrons by increasing the length of the laser pulse, for example, or by tuning the delay between driver bunch and release laser pulse, or a combination of both.

6. In the present invention, the initial and ideally not space-charge increased emittance in the direction perpendicular to the laser polarization direction will be even smaller than in the polarization direction, which especially for low released charges will persist even until large (GeV-scale) energies.

7. The driving electron bunch is compact enough to have an electron density which evokes radial electric fields large enough to drive the blowout, and even better, to ionize the low-ionization species.

8. The dramatically relaxed requirements put on energy spread for the present invention are of benefit to every accelerator source, but especially to laser-plasma-accelerators.

9. Because the driver beams for the present invention do not need narrow energy spreads, this is very advantageous because this challenging tasks disappears. For the present invention, the focus is put on higher charge and compactness, which is easier to accomplish than very narrow energy spreads.

10. Unlike in conventional photocathodes, where electric fields in the MV/m range accelerate the electrons emitted by the solid state cathode, in the present invention the electrons are accelerated, as well as focused, by GV/m scale electric fields.

11. In the present invention the blowout volume, where the electrons are released, is uniformly filled with ions based on the species which is used to produce the accelerating plasma blowout. Furthermore, the release of electrons due to ionization the higher-ionization species does at the same time produce additional positively charged ions on axis.

12. The Rayleigh length of the release laser on axis is maximized over the whole length of trapping positions.

13. Emittance is decreased when operating at shorter wavelengths.

It will also be appreciated that the invention can be embodied in various ways, including but not limited to the following:

1. A method for generating electron and light beams in a hybrid laser-plasma-accelerator, the method comprising: using a particle beam to set up a plasma wave with an electron-cavitated blowout, and using a synchronized laser pulse to release electrons via ionization at arbitrary positions within the blowout

2. A method for generating high-quality electron and light beams with ultrashort pulse length, width, divergence and emittance in a hybrid laser-plasma-accelerator, the method comprising: using a dense particle beam to set up a plasma wave with an electron-cavitated blowout, and using a synchronized low-intensity laser pulse to release electrons via ionization at arbitrary positions within the blowout.

3. The method of any of the preceding embodiments, wherein a high-energy, very compact electron or proton beam produced by a conventional accelerator such as a linac or cyclotron in combination with bunch compression schemes such as via magnetic chicanes or self-modulation in a plasma is used to drive a plasma wave and generate a plasma cavity blowout for accelerating electrons.

4. The method of any of the preceding embodiments, wherein a high-energy, very compact electron beam produced by state-of-the-art laser-plasma-accelerator techniques is used to drive a plasma wave and generate a plasma cavity blowout for accelerating electrons.

5. The method of any of the preceding embodiments, wherein the particle beam driver is intense enough to self-ionize gaseous media in order to prepare a plasma prior to driving the plasma wave and generating the plasma cavity blowout.

6. The method of any of the preceding embodiments, wherein gaseous media is preionized with a laser beam or electric discharge to generate a plasma prior to arrival of the particle beam which then drives the plasma wave and generates the plasma cavity blowout.

7. The method of any of the preceding embodiments, wherein the driving particle beam which sets up the plasma wave is not monoenergetic but has a substantial energy spread of up to tens of percent as long as the individual kinetic particle energies correspond to velocities close to the speed of light in vacuum, i.e. in case of an electron beam driver with energies >>1 MeV and in case of a proton beam driver with energies >>1 GeV.

8. The method of any of the preceding embodiments, wherein the plasma in which the driver beam generates the blowout cavity is based on one or more low-ionization threshold levels of a gaseous medium, for example the first ionization level of lithium, cesium, or rubidium, so that after passage of the driver beam at least one higher ionization level is left unionized and can be used for electron release via ionization of the synchronized laser pulse, such as the second ionization level of lithium, cesium, or rubidium, or a previously completely unionized gas component such as helium.

9. The method of any of the preceding embodiments, wherein the size of the blowout cavity and the corresponding electric fields inside the cavity are tuned by changing the density of the gas component which is ionized after passage of the driver beam, for example the rubidium fraction of a gaseous rubidium/helium mix.

10. The method of any of the preceding embodiments, wherein the size and shape of the plasma blowout cavity and the electric fields formed in the wake of the driver beam are such that neither significant self-injection of background plasma electrons nor self-injection of the species used by the synchronized laser pulse happens at the blowout walls.

11. The method of any of the preceding embodiments, wherein the synchronized laser pulse is focused to an intensity just above the ionization threshold of the high-ionization threshold species, thus releasing electrons into the blowout cavity only in a well-defined focal volume which is much smaller than the blowout itself.

12. The method of any of the preceding embodiments, wherein the initial density of the electrons released in the focal laser volume and thus the charge of the generated electron bunch is tuned by varying the density of the gas component which is ionized by the synchronized laser pulse, for example the helium component in a helium/cesium mixture.

13. The method of any of the preceding embodiments, wherein the synchronized laser pulse is co-propagating collinearly behind the particle driver beam, and the laser pulse is short enough to fit into the plasma blowout cavity.

14. The method of any of the preceding embodiments, wherein the synchronized laser pulse is co-propagating on axis, thus releasing electrons in the focal volume around axis, are trapped and focused on axis and are accelerated to high energies and are then ideally suited to drive a free-electron laser when being fed into a conventional undulator.

15. The method of any of the preceding embodiments, wherein the synchronized laser pulse releases electrons slightly off-axis, which then oscillate around axis in the strong transversal plasma cavity fields, leading to enhanced betatron oscillations and the emission of betatron radiation.

16. The method of any of the preceding embodiments, wherein the synchronized laser pulse propagates through the blowout cavity not collinearly, but at an arbitrary angle, which enables shaping of the generated electron bunch.

17. The method of any of the preceding embodiments, wherein the synchronization between particle beam driver and laser pulse is achieved by splitting off a small fraction of the laser pulse light which is used to produce the particle beam driver pulse in a state-of-the-art laser-plasma-accelerator stage, and the small fraction which has been split off, after passing an adjustable delay line, is then used as an intrinsically perfectly synchronized laser pulse which releases electrons inside the plasma blowout cavity at arbitrary position.

18. The method of any of the preceding embodiments, wherein the laser pulse has arbitrary polarization, such as linear, circular, and elliptical.

19. The method of any of the preceding embodiments, wherein the laser pulse has arbitrary wavelength, including but not restricted to a wavelength of 800 nm, 400 nm, and 266 nm by frequency doubling and/or mixing in a nonlinear crystal such as β-Barium Borate (β-BaB₂O₄ or BBO).

20. A hybrid laser-plasma-accelerator configured for implementing the method of any one or more of the preceding embodiments.

21. A hybrid laser-plasma-accelerator, wherein a particle beam instead of a laser pulse is used to drive the plasma wave, and a synchronized, comparably low-intensity laser pulse is used to release electrons directly at arbitrary positions of the plasma blowout.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

TABLE 1
Decrease Of Laser Contribution To The Normalized Emittance
When Operating And Shorter Release Laser Wavelengths

| λ/μm | w₀/μm | a₀ | εₙ ∞ w₀a₀/m rad | Z_{R}/μm |
|---|---|---|---|---|
| 0.8 | 4.3 | 0.017 | 2.6 × 10⁻⁸ | 101 |
| 0.4 | 2.2 | 0.0085 | 6.6 × 10⁻⁹ | 50 |
| 0.26 | 1.4 | 0.0057 | 2.8 × 10⁻⁹ | 34 |

We claim:

1. A method for generating high-quality electron and light beams with ultrashort pulse length, width, divergence and emittance in a hybrid laser-plasma-accelerator, the method comprising:
using a dense particle beam to set up a plasma wave with an electron-cavitated blowout; and
using a synchronized low-intensity laser pulse to release electrons via ionization at arbitrary positions within the blowout.

2. The method of claim 1, wherein a high-energy, very compact electron or proton beam produced by a conventional accelerator such as a linac or cyclotron in combination with bunch compression schemes such as via magnetic chicanes or self-modulation in a plasma is used to drive a plasma wave and generate a plasma cavity blowout for accelerating electrons.

3. The method of claim 1, wherein a high-energy, very compact electron beam produced by state-of-the-art laser-plasma-accelerator techniques is used to drive a plasma wave and generate a plasma cavity blowout for accelerating electrons.

4. The method of claim 2 or 3, wherein the particle beam driver is intense enough to self-ionize gaseous media in order to prepare a plasma prior to driving the plasma wave and generating the plasma cavity blowout.

5. The method of claim 2 or 3, wherein gaseous media is preionized with a laser beam or electric discharge to generate a plasma prior to arrival of the particle beam which then drives the plasma wave and generates the plasma cavity blowout.

6. The method of claim 2 or 3, wherein the driving particle beam which sets up the plasma wave is not monoenergetic but has a substantial energy spread of up to tens of percent as long as the individual kinetic particle energies correspond to velocities close to the speed of light in vacuum, i.e. in case of an electron beam driver with energies >>1 MeV and in case of a proton beam driver with energies >>1 GeV.

7. The method of claim 4, wherein the plasma in which the driver beam generates the blowout cavity is based on one or more low-ionization threshold levels of a gaseous medium, for example the first ionization level of lithium, cesium, or rubidium, so that after passage of the driver beam at least one higher ionization level is left unionized and can be used for electron release via ionization of the synchronized laser pulse, such as the second ionization level of lithium, cesium, or rubidium, or a previously completely unionized gas component such as helium.

8. The method of claim 5, wherein the plasma in which the driver beam generates the blowout cavity is based on one or more low-ionization threshold levels of a gaseous medium, for example the first ionization level of lithium, cesium, or rubidium, so that after passage of the driver beam at least one higher ionization level is left unionized and can be used for electron release via ionization of the synchronized laser pulse, such as the second ionization level of lithium, cesium, or rubidium, or a previously completely unionized gas component such as helium.

9. The method of claim 7, wherein the size of the blowout cavity and the corresponding electric fields inside the cavity are tuned by changing the density of the gas component which is ionized after passage of the driver beam, for example the rubidium fraction of a gaseous rubidium/helium mix.

10. The method of claim 8, wherein the size of the blowout cavity and the corresponding electric fields inside the cavity are tuned by changing the density of the gas component which is ionized after passage of the driver beam, for example the rubidium fraction of a gaseous rubidium/helium mix.

11. The method of claim 9, wherein the size and shape of the plasma blowout cavity and the electric fields formed in the wake of the driver beam are such that neither significant self-injection of background plasma electrons nor self-injection of the species used by the synchronized laser pulse happens at the blowout walls.

12. The method of claim 10, wherein the size and shape of the plasma blowout cavity and the electric fields formed in the wake of the driver beam are such that neither significant self-injection of background plasma electrons nor self-injection of the species used by the synchronized laser pulse happens at the blowout walls.

13. The method of claim 11, wherein the synchronized laser pulse is focused to an intensity just above the ionization threshold of the high-ionization threshold species, thus releasing electrons into the blowout cavity only in a well-defined focal volume which is much smaller than the blowout itself.

14. The method of claim 12, wherein the synchronized laser pulse is focused to an intensity just above the ionization threshold of the high-ionization threshold species, thus releasing electrons into the blowout cavity only in a well-defined focal volume which is much smaller than the blowout itself.

15. The method of claim 13, wherein the initial density of the electrons released in the focal laser volume and thus the charge of the generated electron bunch is tuned by varying the density of the gas component which is ionized by the synchronized laser pulse, for example the helium component in a helium/cesium mixture.

16. The method of claim 14, wherein the initial density of the electrons released in the focal laser volume and thus the charge of the generated electron bunch is tuned by varying the density of the gas component which is ionized by the synchronized laser pulse, for example the helium component in a helium/cesium mixture.

17. The method of claim 15, wherein the synchronized laser pulse is co-propagating collinearly behind the particle driver beam, and the laser pulse is short enough to fit into the plasma blowout cavity.

18. The method of claim 16, wherein the synchronized laser pulse is co-propagating collinearly behind the particle driver beam, and the laser pulse is short enough to fit into the plasma blowout cavity.

19. The method of claim 17, wherein the synchronized laser pulse is co-propagating on axis, thus releasing electrons in the focal volume around axis, are trapped and focused on axis and are accelerated to high energies and are then ideally suited to drive a free-electron laser when being fed into a conventional undulator.

20. The method of claim 18, wherein the synchronized laser pulse is co-propagating on axis, thus releasing electrons in the focal volume around axis, are trapped and focused on axis and are accelerated to high energies and are then ideally suited to drive a free-electron laser when being fed into a conventional undulator.

21. The method of claim 15, wherein the synchronized laser pulse releases electrons slightly off-axis, which then oscillate around axis in the strong transversal plasma cavity fields, leading to enhanced betatron oscillations and the emission of betatron radiation.

22. The method of claim 16, wherein the synchronized laser pulse releases electrons slightly off-axis, which then oscillate around axis in the strong transversal plasma cavity fields, leading to enhanced betatron oscillations and the emission of betatron radiation.

23. The method of claim 17, wherein the synchronized laser pulse releases electrons slightly off-axis, which then oscillate around axis in the strong transversal plasma cavity fields, leading to enhanced betatron oscillations and the emission of betatron radiation.

24. The method of claim 18, wherein the synchronized laser pulse releases electrons slightly off-axis, which then oscillate around axis in the strong transversal plasma cavity fields, leading to enhanced betatron oscillations and the emission of betatron radiation.

25. The method of claim 15, wherein the synchronized laser pulse propagates through the blowout cavity not collinearly, but at an arbitrary angle, which enables shaping of the generated electron bunch.

26. The method of claim 16, wherein the synchronized laser pulse propagates through the blowout cavity not collinearly, but at an arbitrary angle, which enables shaping of the generated electron bunch.

27. The method of claim 3, wherein the synchronization between particle beam driver and laser pulse is achieved by splitting off a small fraction of the laser pulse light which is used to produce the particle beam driver pulse in a state-of-the-art laser-plasma-accelerator stage, and the small fraction which has been split off, after passing an adjustable delay line, is then used as an intrinsically perfectly synchronized laser pulse which releases electrons inside the plasma blowout cavity at arbitrary position.

28. The method of claim 1, wherein the laser pulse has arbitrary polarization, such as linear, circular, and elliptical.

29. The method of claim 1, wherein the laser pulse has arbitrary wavelength, including but not restricted to a wavelength of 800 nm, 400 nm, and 266 nm by frequency doubling and/or mixing in a nonlinear crystal such as β-Barium Borate (β-BaB₂O₄ or BBO).

30. The method of claim 28, wherein the laser pulse has arbitrary wavelength, including but not restricted to a wavelength of 800 nm, 400 nm, and 266 nm by frequency doubling and/or mixing in a nonlinear crystal such as β-Barium Borate (β-BaB₂O₄ or BBO).

31. A hybrid laser-plasma-accelerator, wherein a particle beam instead of a laser pulse is to drive a plasma wave, and a synchronized, comparably low-intensity laser pulse is used to release electrons directly at arbitrary positions of plasma blowout.
